(19) United States
(12) Patent Application Publication
(10) Pub. No.: US 2026/0120058 A1
(43) Pub. Date: Apr. 30, 2026

(54) INFORMATION EXCHANGE METHOD AND APPARATUS, AND ELECTRONIC DEVICE

(71) Applicant: Beijing Zitiao Network Technology Co., Ltd., Beijing (CN)

(72) Inventors: Yuxiang WANG, Beijing (CN); Qianwen GUO, Beijing (CN)

(21) Appl. No.: 19/004,014

(22) Filed: Dec. 27, 2024

(30) Foreign Application Priority Data
Dec. 28, 2023 (CN) 202311845896.9

(51) Int. Cl. G06Q 10/10; G06Q 10/0633

(52) U.S. Cl. CPC G06Q 10/103; G06Q 10/0633

(57) ABSTRACT

Embodiments of the present disclosure disclose an information exchange method and apparatus, and an electronic device. A specific implementation of the method includes: displaying a flowchart of a first work item in a project management system, where the flowchart of the first work item includes at least one process node; and binding one or more child work items of the first work item to a target node in the at least one process node.

### CROSS-REFERENCE TO RELATED APPLICATION

The present application claims priority of the Chinese Patent Application No. 202311845896.9, filed on Dec. 28, 2023, the disclosure of which is incorporated herein by reference in the present application.

### TECHNICAL FIELD

The present disclosure relates to the field of computer technologies, and in particular, to an information exchange method and apparatus, and an electronic device.

### BACKGROUND

With the development of computers, a user can use an electronic device to implement various functions. For example, the user can interact with another user through the electronic device, or can use the electronic device to promote work.

In some scenarios, a data management-based tool or platform (for example, a project management system) may be built, and a standardized business process may be created, to accelerate project launch and avoid project risks.

### SUMMARY

This section is provided to give a brief overview of concepts, which will be described in detail later in the section DETAILED DESCRIPTION. This section is neither intended to identify key or necessary features of the claimed technical solutions, nor is it intended to be used to limit the scope of the claimed technical solutions.

In a first aspect, an embodiment of the present disclosure provides an information exchange method. The method includes: displaying a flowchart of a first work item in a project management system, where the flowchart of the first work item includes at least one process node; and binding one or more child work items of the first work item to a target node in the at least one process node.

In a second aspect, an embodiment of the present disclosure provides an information exchange apparatus. The apparatus includes: a display unit configured to display a flowchart of a first work item in a project management system, where the flowchart of the first work item includes at least one process node; and a binding unit configured to bind one or more child work items of the first work item to a target node in the at least one process node.

In a third aspect, an embodiment of the present disclosure provides an electronic device. The electronic device includes: one or more processors; and a storage apparatus configured to store one or more programs, where the one or more programs, when executed by the one or more processors, cause the one or more processors to implement the information exchange method according to the first aspect.

In a fourth aspect, an embodiment of the present disclosure provides a computer-readable medium storing computer programs. When the programs are executed by a processor, the steps of the information exchange method according to the first aspect are implemented.

### BRIEF DESCRIPTION OF THE DRAWINGS

The above and other features, advantages, and aspects of embodiments of the present disclosure become more apparent with reference to the following specific implementations and in conjunction with the accompanying drawings. Throughout the drawings, the same or similar reference numerals denote the same or similar elements. It should be understood that the accompanying drawings are schematic, and that parts and elements are not necessarily drawn to scale.

FIG. 1 is a flowchart of an embodiment of an information exchange method according to the present disclosure;

FIG. 2A and FIG. 2B are schematic diagrams of an application scenario of the information exchange method according to the present disclosure;

FIG. 3A and FIG. 3B are schematic diagrams of an application scenario of the information exchange method according to the present disclosure;

FIG. 4A and FIG. 4B are schematic diagrams of an application scenario of the information exchange method according to the present disclosure;

FIG. 5 is a schematic diagram of a structure of an embodiment of an information exchange apparatus according to the present disclosure;

FIG. 6 is a schematic diagram of an example system architecture to which the information exchange method according to an embodiment of the present disclosure may be applied; and

FIG. 7 is a schematic diagram of a basic structure of an electronic device according to an embodiment of the present disclosure.

### DETAILED DESCRIPTION

Embodiments of the present disclosure are described in more detail below with reference to the accompanying drawings. Although some embodiments of the present disclosure are shown in the drawings, it should be understood that the present disclosure may be implemented in various forms and should not be construed as being limited to the embodiments set forth herein. Rather, these embodiments are provided for a more thorough and complete understanding of the present disclosure. It should be understood that the drawings and embodiments of the present disclosure are only for exemplary purposes, and are not intended to limit the scope of protection of the present disclosure.

It should be understood that the various steps described in the method implementations of the present disclosure may be performed in different orders, and/or performed in parallel. Furthermore, additional steps may be included and/or the execution of the illustrated steps may be omitted in the method implementations. The scope of the present disclosure is not limited in this respect.

The terms “include/comprise” used herein and the variations thereof are an open-ended inclusion, namely, “include/comprise but not limited to”. The term “based on” is “at least partially based on”. The term “an embodiment” means “at least one embodiment”. The term “another embodiment” means “at least one another embodiment”. The term “some embodiments” means “at least some embodiments”. Related definitions of the other terms will be given in the description below.

It should be noted that concepts such as “first” and “second” mentioned in the present disclosure are only used to distinguish different apparatuses, modules, or units, and are not used to limit the sequence of functions performed by these apparatuses, modules, or units or interdependence.

It should be noted that the modifiers “one” and “a plurality of” mentioned in the present disclosure are illustrative and not restrictive, and those skilled in the art should understand that unless the context clearly indicates otherwise, it should be understood as “one or more”.

The names of messages or information exchanged between a plurality of apparatuses in the implementations of the present disclosure are used for illustrative purposes only, and are not used to limit the scope of these messages or information.

Here, for the convenience of description, some concepts that may be involved in the present disclosure are first described.

A space is a basic unit of organizing collaboration, and may be management of a single project or a collection of a plurality of projects.

A work item is a work item collaborated by a team, or may also be a collection of items obtained by decomposing a project. Work items may be divided into different types according to different content, for example, features, issues, versions, iterations, milestones, and the like.

A feature may refer to a software function required by a user to solve a specific problem or achieve a specific goal, which may help team members to track specific detailed problems.

An issue refers to a failure to meet an initially defined business feature. For example, a pop-up window does not display.

A view is a set of work item query dimensions frequently focused on by a team and solidified. A view may have a plurality of types, for example, a table, a list, a Kanban, a Gantt chart, metrics, and the like. The table may be an arrangement combination of field information, and data is arranged in a cell mode. The Gantt chart may display a project progress by using a bar chart based on a time dimension. The metrics are a continuous quantitative process of data definition, collection, and analysis for a software development project, process, and product thereof. For example, feature throughput, quality, cycle, and manpower estimation.

Source data is data for targeted measurement of the entire work item. For example, the source data may include work items, such as features, issues, versions, and iterations. The source data may include view data, such as a feature pool in progress, issues to be processed by me, and a user-defined view name. The source data may include a single instance, for example, a data range is a specific feature, issue, version, iteration, and the like.

A role is various roles participating in a project, and one project requires the cooperation and support of different roles.

A process is a basic step in a life cycle of an item, and is composed of process nodes and execution manners in an orderly manner. A node may refer to a stage division point of a process.

A root work item is a work item at an uppermost layer, and may be generally named as a project. The root work item may be associated with a general process of the project.

A child process node, which may also be referred to as a child node, is a node obtained by decomposition in a process of a work item (a root work item or a parent work item of a non-root work item) and associated with the work item (that is, a child work item). Another child process node may be further decomposed in a process of the work item of the node, to implement process nesting. Alternatively, the work item of the node may not be further decomposed.

A child process work item is a work item associated with the child process node.

A task is a smallest unit of item (a special work item), and cannot be further decomposed.

A node owner is a person responsible for a node task, and may be or may not be a handler of the node task.

A node participant is a handler of a node task, but is not a person responsible for the node task.

In one or more embodiments of the present disclosure, a child work item may be newly created under a node. The child work item belongs to a work item to which the node belongs, but has a binding relationship with the node, that is, child work items of the work item are grouped according to nodes in a flowchart.

In one or more embodiments of the present disclosure, the completion of the work item may depend on a completion status of child work items included in the work item. The completion of a node in a flowchart of the work item may depend on a completion status of a child work item bound to the node.

In one or more embodiments of the present disclosure, a child work item may be created on a node of the work item, and the created child work item naturally has a binding relationship with the node. The child work item bound to the node may be created in a space management interface of a space to which the work item belongs. The child work item bound to the node may be created on an instance side of the work item, for example, in a work item details interface of the work item.

In one or more embodiments of the present disclosure, the work item may be configured on a space side of the work item. Configurable content of the child work item may include a work item type, and the work item type may only be selectable from work item types of the space. After the work item type is selected, a parent-child relationship with a current work item as a parent and a child work item as a child may be selected, to create the child work item. A table view of the child work item may be configured for the node. A name, a person, a node in progress, and node estimation and scheduling may be configured for the node flow work item by default. A name, a person, a status estimation field, and a scheduling field may be configured for the status flow work item by default.

In one or more embodiments of the present disclosure, the child work item under the node may be displayed on the instance side of the work item, and child work items of different types are displayed separately. The child work item may be displayed in a table view. The child work items may be hierarchically dependent. For example, b is a child work item of a, c is a child work item of b, and d is a child work item of c. A dependency of the child work items may be set to a limited number of hierarchical levels, for example, 5 hierarchical levels.

In one or more embodiments of the present disclosure, a parent-child relationship verification may be set when a child work item or a parent work item is added.

For example, when the child work item is added to the work item, it is verified whether a superior work items (for example, a parent work item, a parent work item of the parent work item, a parent work item of the parent work item of the parent work item, and the like) of the work item includes the child work item to be added. If yes, it indicates that the child work item to be added and the work item form a loop, and the adding fails.

For another example, when the parent work item is added to the work item, it is verified whether inferior work items (for example, a child work item, a child work item of the child work item, a child work item of the child work item of the child work item, and the like) of the work item includes the parent work item to be added. If yes, it indicates that the parent work item to be added and the work item form a loop, and the adding fails.

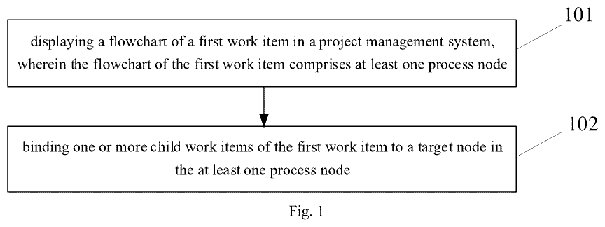

FIG. 1 is a flowchart of an embodiment of an information exchange method according to the present disclosure. As shown in FIG. 1, the information exchange method includes the following steps.

Step 101: displaying a flowchart of a first work item in a project management system.

In this embodiment, an execution subject (for example, a server and/or a terminal device) of the information exchange method may display the flowchart of the first work item in the project management system.

Step 102: binding one or more child work items of the first work item to a target node in the at least one process node.

Here, the flowchart of the first work item may be a work item flowchart of the first work item. The flowchart of the first work item includes at least one process node. The target node may be any process node in the flowchart of the first work item.

Here, the first work item may have child work items. One or more child work items in the first work item may be bound to the target node.

For example, the first work item has a child work item a and a child work item b. The child work item a may be bound to a first node in the process nodes. The child work item b may be bound to a second node in the process nodes.

Here, the child work item may be first created for the first work item, and then the created child work item is bound to the target node. Alternatively, the child work item may be created under the target node. In this case, the created work item naturally has a binding relationship with the target node.

For example, the flowchart of the first work item may be displayed on a space side of a project space to which the first work item belongs or on an instance side of the first work item. Correspondingly, a child work item is bound to the target node in the displayed flowchart of the first work item on the space side of the project space to which the first work item belongs or on the instance side of the first work item.

It should be noted that in the information exchange method provided in this embodiment, by displaying the flowchart of the first work item and binding the one or more child work items of the first work item to the target node, the child work items of the first work item may be grouped according to the nodes in the work item flowchart, to manage the child work items of the first work item according to the nodes, clarify a promotion sequence between the child work items in the first work item, and thereby improve management and promotion efficiency of the first work item.

In some embodiments, the method further includes: determining whether the target node is completed based on a node completion condition pre-configured for the target node.

Here, the node completion condition includes the completion of the one or more work items. Optionally, the node completion condition includes a child work item identifier in the one or more child work items, and the completion of the child work item indicated by the child work item identifier in the node completion condition is a necessary condition for the completion of the target node.

Here, the node completion condition of the target node may be pre-configured. The node completion condition may indicate a necessary condition for the completion of the node. The node completion condition may include conditions in a plurality of aspects, for example, a child work item aspect, a working hour aspect, and a person responsible aspect.

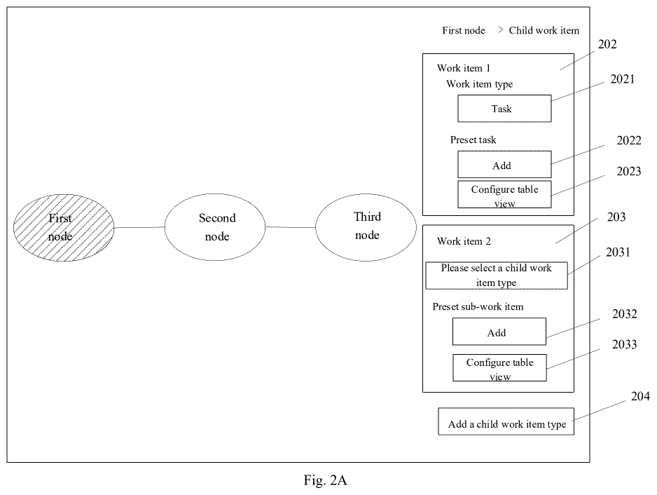

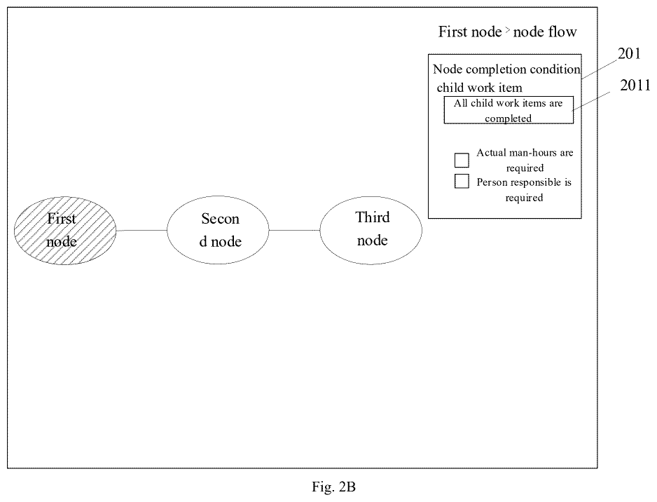

For example, with reference to FIG. 2B, it is also possible to select that actual working hours are required as the node completion condition. Alternatively, it is also possible to select that a person responsible is required as the node completion condition.

In some embodiments, the node completion condition includes any one of the following: all child work items bound to the target node are completed; and part of child work items bound to the target node are completed, the part of child work items is determined based on a specified operation.

For example, with reference to the node flow interface of the first node in FIG. 2B, a node completion condition configured therein may be referred to. Here, a node completion condition configuration interface 201 may include a child work item condition configuration control 2011. In the child work item condition configuration control 2011, an option that all child work items are completed may be selected, that is, the completion of all child work items is a necessary condition for the completion of the node.

For example, a specified work item completion option may also be selected in the work item condition configuration control, and the specified work item completion option may be selected based on a work item specifying operation. For example, when a user selects the specified work item completion option, a plurality of candidate child work items bound to the first node may be displayed, and the user selects a work item from the plurality of candidate child work items as a specified work item. The completion of the specified work item is a necessary condition for the completion of the first node.

It should be noted that determining whether the node is completed based on the completion status of the child work item bound to the first node may automatically determine the completion of the node based on the completion of the child work item, thereby improving the efficiency of node flow.

In some embodiments, step 101 includes: displaying the flowchart of the first work item in a project space interface of a project space to which the first work item belongs.

In some embodiments, step 102 includes: adding a child work item of the first work item for the target node.

Here, the child work item that is added has a binding relationship with the target node.

For example, with reference to FIG. 2A. FIG. 2A shows a project space interface, in which a first node in a flowchart of a first work item is in a selected state. A child work item of the first work item may be newly added for the first node. For example, the newly added child work item may have a binding relationship with the target node. Here, it may be understood as creating the child work item under the first node.

It should be noted that the child work item of the first work item is newly added for the target node in the project space interface, so that the child work item may be configured on the space side, to implement centralized management and configuration of the first work item, and improve the management efficiency of the first child work item.

In some embodiments, the adding a child work item of the first work item for the target node includes: adding a first work item type for the target node; and adding a child work item belonging to the first work item type under the first work item type that is added, the child work item that is added has a binding relationship with the target node.

For example, with reference to FIG. 2A, FIG. 2A shows the newly added child work item according to the work item type. The child work item may be configured in a configuration area 202 of a work item 1. For example, a work item type such as a task is configured in a work item type configuration control 2021. A preset task may include a trigger add control 2022, and one or more sub-tasks may be newly added as the child work item of the work item.

For example, a child work item type may be selected in a work item type configuration control 2031 in a configuration area 203 of a work item 2 in FIG. 2A. For example, a feature type may be selected as the type of the child work item. A trigger add control 2032 may be triggered to add one or more child work items.

In this way, the child work items may be newly added in batch for the target node according to the work item type, thereby improving the efficiency of configuring the child work items.

In some embodiments, the method further includes one or more of the following: configuring a table view format for a first work item type, the table view format indicates a format of a table view for displaying a child work item belonging to the first work item type; and configuring at least one selected from group of the following for the child work item under the first work item type: a child work item form, a person concerned of the child work item, and a flow condition of the child work item.

Here, the table view format may be configured for the first work item type, and the view format may indicate a format used when the child work item of the first work item type is displayed on the instance side. The format of the table view may include, but is not limited to, at least one selected from group of the following: selection of displayed fields, permission configuration, table row height and column width, and the like.

For example, a table view configuration control 2023 in FIG. 2A may be triggered to configure the table view when the child work item of the task type is displayed.

For example, a table view configuration control 2033 in FIG. 2A may be triggered to configure the format of the table view when the child work item corresponding to the work item 2 is displayed.

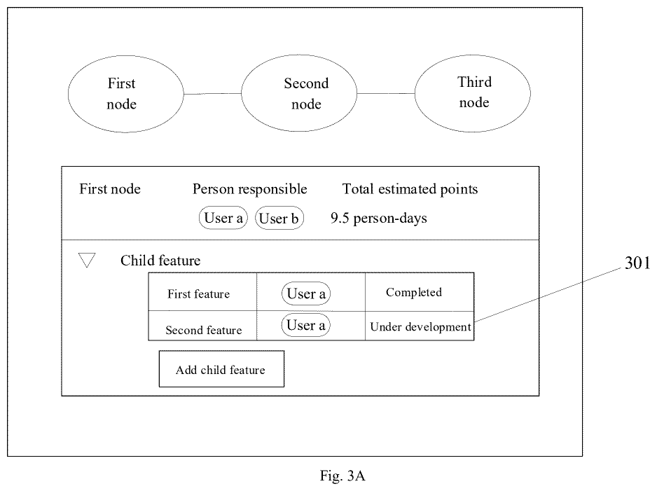

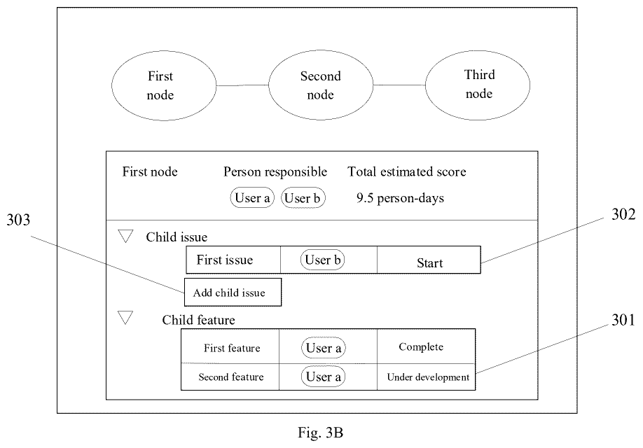

For example, with reference to FIG. 3A, FIG. 3A shows a flowchart of the first work item displayed on the instance side. A currently selected node is a first node, and the first node is bound to child work items of a feature type. The child work items of the feature type may include a first feature and a second feature, and the first feature and the second feature are displayed in a table view 301, and the format of the table view 301 is configured on the space side.

In this way, the display manner of the child work item of the work item type may be quickly determined for the work item type, thereby improving the configuration efficiency.

Here, the person concerned of the child work item, the flow condition of the child work item, and the like under the child work item of the first work item type may also be configured in a centralized manner. The child work item form may include a child work item name, a child work item identifier, and the like. The person concerned of the child work item may include a specific person responsible for each role of the child work item. The flow condition of the child work item may be used to indicate a condition that needs to be satisfied for the completion and flow of the child work item.

In this way, various contents of the child work item may be configured in batch for the child work item of the first work item type, thereby improving the configuration efficiency.

In some embodiments, step 101 includes: displaying the flowchart of the first work item in a work item details interface of the first work item.

In some embodiments, the method further includes: displaying child work item information bound to the target node in response to a select operation for the target node.

For example, with reference to FIG. 3A, FIG. 3A shows a flowchart of the first work item displayed on the instance side. A currently selected node is a first node, and the first node is bound to child work items of a feature type. The child work items of the feature type may include a first feature and a second feature, and the first feature and the second feature are displayed in a table view 301. The child work item information bound to the first node is displayed in the table view 301.

In this way, the child work items bound to each node may be viewed according to the nodes on a details page of the work item, which is convenient for promoting the child work items according to the sequence of the nodes. The promotion speed of the first work item is improved.

In some embodiments, the child work item information bound to the target node is displayed in groups according to work item types.

For example, with reference to FIG. 2B, child work items of an issue type and child work items of a feature type are shown in FIG. 2B. The child work items of the issue type are displayed in a table 302. The child work items of the feature type are displayed in a table 301. The child work items of the two different types are displayed in groups.

In this way, the clarity of displaying the child work items of different types may be improved, which is convenient for promoting the child work items according to the work item types, and for different persons responsible to manage the child work items according to the different work item types.

In some embodiments, the method further includes: adding a child work item of the first work item in response to the target node being in a selected state, the child work item that is added has a binding relationship with the target node.

For example, with reference to FIG. 3B, when the first node in FIG. 3B is selected, the child work item of the first work item is newly added, and the live broadcast item naturally has a binding relationship with the first node. For example, a new control 304 in FIG. 2B may be triggered to create a child work item of the issue type. The newly created child work item of the issue type has a binding relationship with the first node, and is of the issue type. After the creation is completed, the child work item is displayed in the table 302.

In this way, the child work item of the first work item bound to the node may be quickly created on the details page of the work item.

In some embodiments, the method further includes: displaying a parent work item field of the first work item and parent work item information of the first work item in a first work item related interface in the project management system.

The first work item related interface may be used to display a related situation of the first work item. The first work item related interface includes, but is not limited to, at least one selected from group of the following: a details page of the first work item, a node form, a new page, a status form, and an associated work item interface.

Here, the parent field is clearly set for the first work item, and the parent work item information of the first work item is displayed.

Optionally, the parent field may be used for grouping, filtering, and the like.

In some related technologies, in an interface of a parent work item of the first work item, a child work item is displayed, and the parent work item cannot be displayed in a related interface of the child work item. Here, the parent field is clearly set, and the parent field and the child field of the first work item may be clearly seen, to clarify a hierarchical relationship between the work items.

In some embodiments, the method further includes: displaying a plurality of candidate parent work items grouped according to work item types in response to a parent work item adding operation; and using a candidate parent work item targeted by a select operation as a parent work item of the first work item according to the select operation for the plurality of candidate parent work items.

Optionally, the parent work item is bound to the target node.

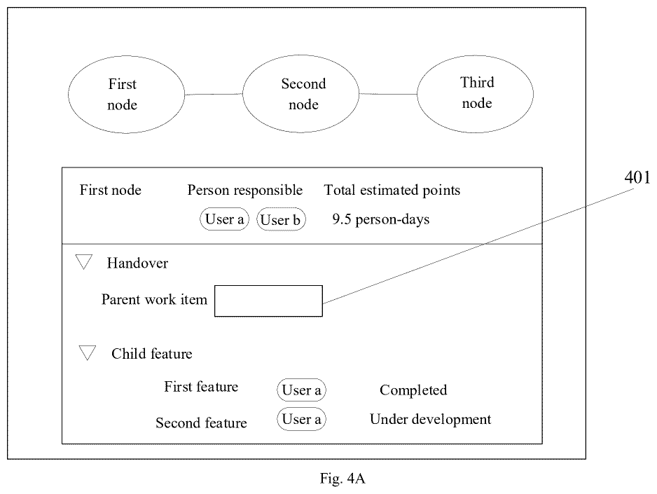

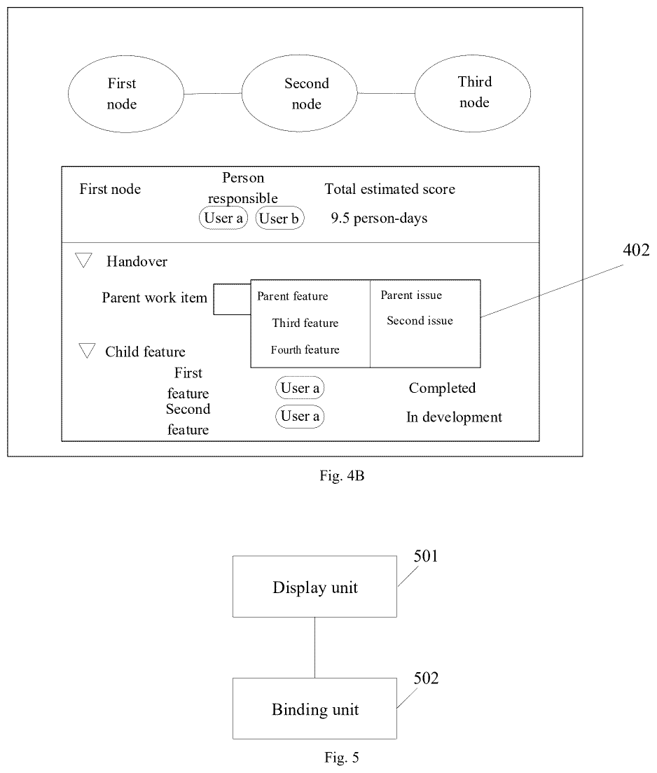

For example, a parent work item add control 401 in FIG. 4A may be triggered to add the parent work item. When the parent work item add control 401 is triggered, a select panel 402 may be displayed. As shown in FIG. 4B, the candidate parent work items in the select panel 402 are grouped according to work item types. For example, a second issue of an issue type is grouped with a third feature and a fourth feature of a feature type for display. According to the select operation for the plurality of candidate parent work items, the parent work item targeted by the select operation, for example, the second issue, is used as the parent work item of the first work item.

In this way, the parent work item of the specified work item type may be quickly added for the first work item.

In some embodiments, the method further includes at least one selected from group of the following: in response to a parent work item adding operation for the first work item, confirming whether superior work items of a parent work item to be added include the first work item, and in response to the superior work items of the parent work item to be added including the first work item, determining that the adding fails; and in response to a child work item adding operation for the first work item, determining whether inferior work items of a child work item to be added include the first work item, and in response to the inferior work item of the child work items to be added including the first work item, determining that the child work item adding operation fails, the superior work items include N-level parent work items of the parent work item to be added; and the inferior work items include M-level child work items of the child work item to be added.

Both M and N are positive integers greater than 1. It may be understood that the Nth level is the number of all hierarchical levels in an upward dependency relationship of the first work item. It may be understood that the Mth level is the number of all hierarchical levels in a downward dependency relationship of the first work item.

For example, a work item A is a parent work item of a work item B, the work item B is a parent work item of a work item C, and the work item C is a parent work item of a work item D.

If the child work item is added for the work item A, it is necessary to verify whether inferior work items of the work item A, that is, the work item B, the work item C, and the work item D, include the child work item to be added. If yes, it is determined that the adding fails.

If the parent work item is added for the work item D, it is necessary to verify whether superior work items of the work item D, that is, the work item A, the work item B, and the work item C, include the parent work item to be added. If yes, it is determined that the adding fails.

Here, it may be verified whether a start and an end of a work item with a parent-child dependency relationship form a loop. When the parent work item is added, starting from a child of a current work item, all descendants of the current child are viewed to check whether there is a parent in the current work item. When the child work item is added, starting from a parent of the current work item, all parents, grandparents, and the like of the current parent are viewed to check whether there is a child of the current work item. If the start and the end of the work item with the parent-child dependency relationship form the loop, the adding of the parent work item or the child work item fails this time.

In this way, a disorder of the parent-child relationship may be avoided, and the accuracy of project management is improved.

With further reference to FIG. 5, as an implementation of the method shown in the foregoing figures, the present disclosure provides an embodiment of an information exchange apparatus. This apparatus embodiment corresponds to the method embodiment shown in FIG. 1, and the apparatus may be specifically applied to various electronic devices.

As shown in FIG. 5, the information exchange apparatus in this embodiment includes: a display unit 501 and a binding unit 502. The display unit is configured to display a flowchart of a first work item in a project management system, the flowchart of the first work item includes at least one process node. The binding unit is configured to bind one or more child work items of the first work item to a target node in the at least one process node.

In this embodiment, for specific processing of the display unit 501 and the binding unit 502 of the information exchange apparatus and a technical effect brought thereby, reference may be made to the related descriptions of step 101 and step 102 in the corresponding embodiment in FIG. 1 respectively, and details are not described herein again.

In some embodiments, the apparatus is further configured to: determine whether the target node is completed based on a node completion condition pre-configured for the target node, the node completion condition includes a child work item identifier in the one or more child work items, and the completion of the child work item indicated by the child work item identifier in the node completion condition is a necessary condition for the completion of the target node.

In some embodiments, the node completion condition includes any one of the following: all child work items bound to the target node are completed; and part of child work items bound to the target node are completed, the part of child work items is determined based on a specified operation.

In some embodiments, the displaying a flowchart of a first work item in a project management system includes: displaying the flowchart of the first work item in a project space interface of a project space to which the first work item belongs; and the binding one or more child work items of the first work item to a target node in the at least one process node includes: adding a child work item of the first work item for the target node, a first child work item that is added has a binding relationship with the target node.

In some embodiments, the adding a child work item of the first work item for the target node includes: adding a first work item type for the target node; and adding a child work item belonging to the first work item type under the first work item type that is added, the child work item that is added has a binding relationship with the target node.

In some embodiments, the apparatus is further configured to perform one or more of the following: configuring a table view format for a first work item type, the table view format indicates a format of a table view for displaying a child work item belonging to the first work item type; and configuring at least one selected from group of the following for the child work item under the first work item type: a child work item form, a person concerned of the child work item, and a flow condition of the child work item.

In some embodiments, the displaying a flowchart of a first work item in a project management system includes: displaying the flowchart of the first work item in a work item details interface of the first work item; and the apparatus is further configured to: display child work item information bound to the target node in response to a select operation for the target node.

In some embodiments, the child work item information bound to the target node is displayed in groups according to work item types.

In some embodiments, the binding unit is further configured to: add a child work item of the first work item in response to the target node being in a selected state, the child work item that is added has a binding relationship with the target node.

In some embodiments, the binding unit is further configured to: bind one or more established child work items of the first work item to the target node in the at least one process node.

In some embodiments, the apparatus is further configured to: display a parent work item field of the first work item and parent work item information of the first work item in a first work item related interface in the project management system.

In some embodiments, the apparatus is further configured to: display a plurality of candidate parent work items grouped according to work item types in response to a parent work item adding operation; and use a candidate parent work item targeted by a select operation as a parent work item of the first work item according to the select operation for the plurality of candidate parent work items.

In some embodiments, the apparatus is further configured to perform at least one selected from group of the following: in response to a parent work item adding operation for the first work item, confirming whether superior work items of a parent work item to be added include the first work item, and in response to the superior work items of the parent work item to be added including the first work item, determining that the parent work item adding operation fails; and in response to a child work item adding operation for the first work item, determining whether inferior work items of a child work item to be added include the first work item, and in response to the inferior work item of the child work items to be added including the first work item, determining that the child work item adding operation fails, the superior work items include N-level parent work items of the parent work item to be added; and the inferior work items include M-level child work items of the child work item to be added.

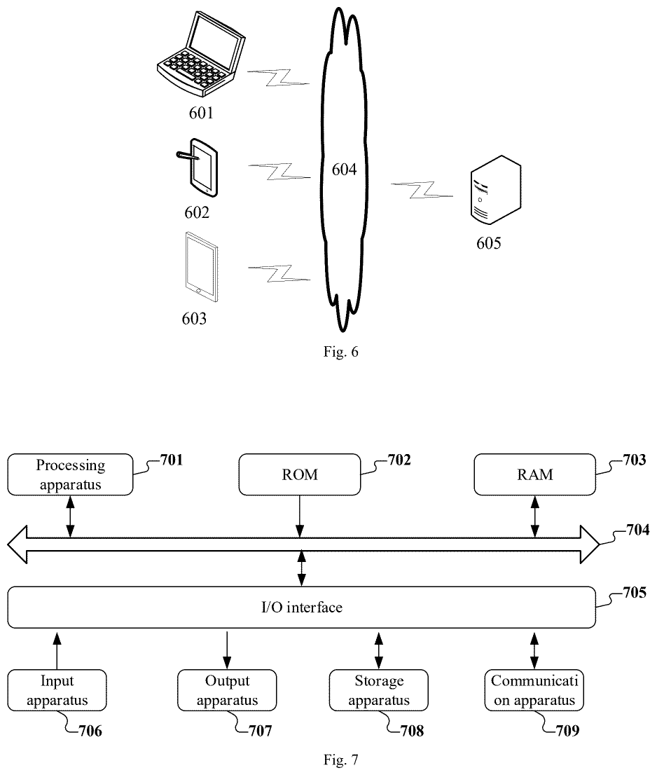

FIG. 6 shows an example system architecture to which the information exchange method according to an embodiment of the present disclosure may be applied.

As shown in FIG. 6, the system architecture may include terminal devices 601, 602, and 603, a network 604, and a server 605. The network 604 provides a medium for a communication link between the terminal devices 601, 602, and 603 and the server 605. The network 604 may include various connection types, such as a wired or wireless communication link, or an optic fiber cable.

The terminal devices 601, 602, and 603 may interact with the server 605 through the network 604 to receive or send messages, etc. Various client applications may be installed on the terminal devices 601, 602, and 603, such as a web browser application, a search application, and a news information application. The client applications in the terminal devices 601, 602, and 603 may receive instructions from users, and complete corresponding functions according to the instructions from the users, for example, adding corresponding information to information according to the instructions from the users.

The terminal devices 601, 602, and 603 may be hardware or software. When the terminal devices 601, 602, and 603 are hardware, they may be various electronic devices with a display screen and supporting web browsing, including but not limited to a smart phone, a tablet computer, an e-book reader, an MP3 (Moving Picture Experts Group Audio Layer III) player, an MP4 (Moving Picture Experts Group Audio Layer IV) player, a laptop computer, and a desktop computer. When the terminal devices 601, 602, and 603 are software, they may be installed in the foregoing enumerated electronic devices. The terminal devices 601, 602, and 603 may be implemented as multiple software or software modules (for example, software or software modules used to provide distributed services), or may be implemented as a single software or software module. This is not specifically limited here.

The server 605 may be a server that provides various services, for example, receives an information obtaining request sent by the terminal devices 601, 602, and 603, and obtains display information corresponding to the information obtaining request in various manners according to the information obtaining request. The server 605 sends related data of the display information to the terminal devices 601, 602, and 603.

It should be noted that the information exchange method provided in this embodiment of the present disclosure may be performed by the terminal devices, and accordingly, the information exchange apparatus may be disposed in the terminal devices 601, 602, and 603. In addition, the information exchange method provided in this embodiment of the present disclosure may also be performed by the server 605, and accordingly, the information exchange apparatus may be disposed in the server 605.

It should be understood that the numbers of the terminal devices, the network, and the server in FIG. 6 are merely illustrative. Depending on requirements, there may be any number of terminal devices, networks, and servers.

FIG. 7 is a schematic structural diagram of an electronic device (for example, the terminal device or the server in FIG. 6) suitable for implementing the embodiments of the present disclosure. The terminal device in the embodiments of the present disclosure may include, but is not limited to, mobile terminals such as a mobile phone, a notebook computer, a digital broadcast receiver, a personal digital assistant (PDA), a tablet computer (PAD), a portable multimedia player (PMP), and a vehicle-mounted terminal (for example, a vehicle navigation terminal), and fixed terminals such as a digital TV and a desktop computer. The electronic device shown in FIG. 7 is merely an example, and shall not impose any limitation on the function and scope of use of the embodiments of the present disclosure.

As shown in FIG. 7, the electronic device may include a processing apparatus (for example, a central processing unit, a graphics processing unit, etc.) 701 that may perform a variety of appropriate actions and processing in accordance with a program stored in a read-only memory (ROM) 702 or a program loaded from a storage apparatus 708 into a random access memory (RAM) 703. The RAM 703 further stores various programs and data required for the operation of the electronic device 700. The processing apparatus 701, the ROM 702, and the RAM 703 are connected to each other through a bus 704. An input/output (I/O) interface 705 is also connected to the bus 704.

Generally, the following apparatuses may be connected to the I/O interface 705: an input apparatus 706 including, for example, a touch screen, a touchpad, a keyboard, a mouse, a camera, a microphone, an accelerometer, and a gyroscope; an output apparatus 707 including, for example, a liquid crystal display (LCD), a speaker, and a vibrator; the storage apparatus 708 including, for example, a tape and a hard disk; and a communication apparatus 709. The communication apparatus 709 may allow the electronic device to perform wireless or wired communication with other devices to exchange data. Although FIG. 7 shows the electronic device having various apparatuses, it should be understood that it is not required to implement or have all of the shown apparatuses. It may be an alternative to implement or have more or fewer apparatuses.

In particular, according to an embodiment of the present disclosure, the process described above with reference to the flowcharts may be implemented as a computer software program. For example, this embodiment of the present disclosure includes a computer program product, which includes computer programs carried on a non-transitory computer-readable medium, where the computer programs include program code for performing the method shown in the flowchart. In such an embodiment, the computer program may be downloaded and installed from a network through the communication apparatus 709, installed from the storage apparatus 708, or installed from the ROM 702. When the computer program is executed by the processing apparatus 701, the above-mentioned functions defined in the method of the embodiment of the present disclosure are performed.

It should be noted that the computer-readable medium described above in the present disclosure may be a computer-readable signal medium, a computer-readable storage medium, or any combination thereof. The computer-readable storage medium may be, for example but not limited to, electric, magnetic, optical, electromagnetic, infrared, or semiconductor systems, apparatuses, or devices, or any combination thereof. A more specific example of the computer-readable storage medium may include, but is not limited to: an electrical connection having one or more wires, a portable computer magnetic disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof. In the present disclosure, the computer-readable storage medium may be any tangible medium containing or storing a program which may be used by or in combination with an instruction execution system, apparatus, or device. In the present disclosure, the computer-readable signal medium may include a data signal propagated in a baseband or as a part of a carrier, the data signal carrying computer-readable program code. This propagated data signal may be in various forms, including but not limited to an electromagnetic signal, an optical signal, or any suitable combination thereof. The computer-readable signal medium may also be any computer-readable medium other than the computer-readable storage medium. The computer-readable signal medium may send, propagate, or transmit a program used by or in combination with an instruction execution system, apparatus, or device. The program code contained in the computer-readable medium may be transmitted by any suitable medium, including but not limited to: electric wires, optical cables, radio frequency (RF), etc., or any suitable combination thereof.

In some implementations, the client and the server may communicate using any currently known or future-developed network protocol such as a hypertext transfer protocol (HTTP), and may be connected to digital data communication (for example, a communication network) in any form or medium. Examples of the communication network include a local area network (“LAN”), a wide area network (“WAN”), an internetwork (for example, the Internet), a peer-to-peer network (for example, an ad hoc peer-to-peer network), and any currently known or future-developed network.

The above computer-readable medium may be contained in the above electronic device; or may exist independently without being assembled into the electronic device.

The above computer-readable medium carries one or more programs, and when the one or more programs are executed by the electronic device, the electronic device is caused to: display a flowchart of a first work item in a project management system, the flowchart of the first work item includes at least one process node; and bind one or more child work items of the first work item to a target node in the at least one process node.

The computer program code for performing the operations in the present disclosure may be written in one or more programming languages or a combination thereof, where the programming languages include but are not limited to an object-oriented programming language, such as Java, Smalltalk, and C++, and further include conventional procedural programming languages, such as “C” language or similar programming languages. The program code may be completely executed on a computer of a user, partially executed on a computer of a user, executed as an independent software package, partially executed on a computer of a user and partially executed on a remote computer, or completely executed on a remote computer or server. In the circumstance involving the remote computer, the remote computer may be connected to the computer of the user over any type of network, including a local area network (LAN) or a wide area network (WAN), or may be connected to an external computer (for example, connected over the Internet using an Internet service provider).

The flowcharts and block diagrams in the accompanying drawings illustrate the possibly implemented architecture, functions, and operations of the system, the method, and the computer program product according to various embodiments of the present disclosure. In this regard, each block in the flowchart or block diagram may represent a module, program segment, or part of code, and the module, program segment, or part of code contains one or more executable instructions for implementing the specified logical functions. It should also be noted that in some alternative implementations, the functions marked in the blocks may also occur in an order different from that marked in the accompanying drawings. For example, two blocks shown in succession can actually be executed substantially in parallel, or they can sometimes be executed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The related units described in the embodiments of the present disclosure may be implemented by means of software, or may be implemented by means of hardware. The name of a unit does not constitute a limitation on the unit in some cases, for example, the display unit may also be described as “a unit for displaying a flowchart”.

The functions described herein above may be performed at least partially by one or more hardware logic components. For example, without limitation, exemplary types of hardware logic components that may be used include: a field programmable gate array (FPGA), an application-specific integrated circuit (ASIC), an application-specific standard product (ASSP), a system on chip (SOC), a complex programmable logic device (CPLD), and the like.

In the context of the present disclosure, a machine-readable medium may be a tangible medium that may contain or store a program used by or in combination with an instruction execution system, apparatus, or device. The machine-readable medium may be a machine-readable signal medium or a machine-readable storage medium. The machine-readable medium may include, but is not limited to, electronic, magnetic, optical, electromagnetic, infrared, or semiconductor systems, apparatuses, or devices, or any suitable combination thereof. A more specific example of the machine-readable storage medium may include an electrical connection based on one or more wires, a portable computer disk, a hard disk, a random access memory (RAM), a read-only memory (ROM), an erasable programmable read-only memory (EPROM or flash memory), an optic fiber, a portable compact disk read-only memory (CD-ROM), an optic storage device, a magnetic storage device, or any suitable combination thereof.

The foregoing descriptions are merely preferred embodiments of the present disclosure and explanations of the applied technical principles. A person skilled in the art should understand that the scope of disclosure involved in the present disclosure is not limited to the technical solutions formed by a specific combination of the foregoing technical features, and shall also cover other technical solutions formed by any combination of the foregoing technical features or equivalent features thereof without departing from the foregoing concept of disclosure. For example, the technical solutions formed by replacing the foregoing features with the technical features disclosed in the present disclosure (but not limited to) and having similar functions.

In addition, although the various operations are depicted in a specific order, it should be understood as requiring these operations to be performed in the specific order shown or in a sequential order. Under specific circumstances, multitasking and parallel processing may be advantageous. Similarly, although several specific implementation details are included in the foregoing discussions, these details should not be construed as limiting the scope of the present disclosure. Certain features that are described in the context of separate embodiments may alternatively be implemented in combination in a single embodiment. In contrast, various features described in a single embodiment may alternatively be implemented in a plurality of embodiments individually or in any suitable sub-combination.

Although the subject matter has been described in a language specific to structural features and/or logical actions of the method, it should be understood that the subject matter defined in the appended claims is not necessarily limited to the specific features or actions described above. In contrast, the specific features and actions described above are merely exemplary forms of implementing the claims.

1. An information exchange method, comprising:
displaying a flowchart of a first work item in a project management system, wherein the flowchart of the first work item comprises at least one process node; and
binding one or more child work items of the first work item to a target node in the at least one process node.

2. The method according to claim 1, wherein the method further comprises:
determining whether the target node is completed based on a node completion condition pre-configured for the target node,
wherein the node completion condition comprises that the one or more child work items are completed.

3. The method according to claim 2, wherein the node completion condition comprises any one of the following:
all child work items bound to the target node are completed; and
part of child work items bound to the target node are completed, wherein the part of child work items is determined based on a specified operation.

4. The method according to claim 1, wherein the displaying the flowchart of the first work item in the project management system comprises:
displaying the flowchart of the first work item in a project space interface of a project space to which the first work item belongs; and
the binding the one or more child work items of the first work item to the target node in the at least one process node comprises:
adding a child work item of the first work item for the target node, wherein a first child work item that is added has a binding relationship with the target node.

5. The method according to claim 4, wherein the adding the child work item of the first work item for the target node comprises:
adding a first work item type for the target node; and
adding a child work item belonging to the first work item type under the first work item type that is added, wherein the child work item that is added has a binding relationship with the target node.

6. The method according to claim 4, wherein the method further comprises one or more of the following:
configuring a table view format for a first work item type, wherein the table view format indicates a format of a table view for displaying a child work item belonging to the first work item type; and
configuring at least one selected from group of the following for the child work item under the first work item type: a child work item form, a person concerned of the child work item, and a flow condition of the child work item.

7. The method according to claim 1, wherein the displaying the flowchart of the first work item in the project management system comprises:
displaying the flowchart of the first work item in a work item details interface of the first work item; and
the method further comprises:
displaying child work item information bound to the target node in response to a select operation for the target node.

8. The method according to claim 7, wherein the child work item information bound to the target node is displayed in groups according to work item types.

9. The method according to claim 1, wherein the binding the one or more child work items of the first work item to the target node in the at least one process node comprises:
adding a child work item of the first work item in response to the target node being in a selected state, wherein the child work item that is added has a binding relationship with the target node.

10. The method according to claim 1, wherein the binding the one or more child work items of the first work item to the target node in the at least one process node comprises:
binding one or more established child work items of the first work item to the target node in the at least one process node.

11. The method according to claim 1, wherein the method further comprises:
displaying a parent work item field of the first work item and parent work item information of the first work item in a first work item related interface in the project management system.

12. The method according to claim 11, wherein the method further comprises:
displaying a plurality of candidate parent work items grouped according to work item types in response to a parent work item adding operation; and
using a candidate parent work item targeted by a select operation as a parent work item of the first work item according to the select operation for the plurality of candidate parent work items.

13. The method according to claim 1, wherein the method further comprises at least one selected from group of the following:
in response to a parent work item adding operation for the first work item, confirming whether superior work items of a parent work item to be added include the first work item, and in response to the superior work items of the parent work item to be added including the first work item, determining that the parent work item adding operation fails; and
in response to a child work item adding operation for the first work item, determining whether inferior work items of a child work item to be added include the first work item, and in response to the inferior work item of the child work items to be added including the first work item, determining that the child work item adding operation fails,
wherein the superior work items comprise N-level parent work items of the parent work item to be added; and
the inferior work items comprise M-level child work items of the child work item to be added.

14. An electronic device, comprising:
one or more processors; and
a storage apparatus configured to store one or more programs, wherein
the one or more programs, when executed by the one or more processors, cause the one or more processors to implement:
displaying a flowchart of a first work item in a project management system, wherein the flowchart of the first work item comprises at least one process node; and
binding one or more child work items of the first work item to a target node in the at least one process node.

15. The electronic device according to claim 14, wherein the one or more programs, when executed by the one or more processors, cause the one or more processors to further implement:
determining whether the target node is completed based on a node completion condition pre-configured for the target node,
wherein the node completion condition comprises that the one or more child work items are completed.

16. The electronic device according to claim 14, wherein the displaying the flowchart of the first work item in the project management system comprises:
displaying the flowchart of the first work item in a project space interface of a project space to which the first work item belongs; and
the binding the one or more child work items of the first work item to the target node in the at least one process node comprises:
adding a child work item of the first work item for the target node, wherein a first child work item that is added has a binding relationship with the target node.

17. The electronic device according to claim 14, wherein the displaying the flowchart of the first work item in the project management system comprises:
displaying the flowchart of the first work item in a work item details interface of the first work item; and
the one or more programs, when executed by the one or more processors, cause the one or more processors to further implement:
displaying child work item information bound to the target node in response to a select operation for the target node.

18. The electronic device according to claim 14, wherein the binding the one or more child work items of the first work item to the target node in the at least one process node comprises:
adding a child work item of the first work item in response to the target node being in a selected state, wherein the child work item that is added has a binding relationship with the target node.

19. The electronic device according to claim 14, wherein the binding the one or more child work items of the first work item to the target node in the at least one process node comprises:
binding one or more established child work items of the first work item to the target node in the at least one process node.

20. A computer-readable medium storing computer programs, wherein the programs, when executed by a processor, implement:
displaying a flowchart of a first work item in a project management system, wherein the flowchart of the first work item comprises at least one process node; and
binding one or more child work items of the first work item to a target node in the at least one process node.
